(19) United States
(12) Patent Application Publication
(10) Pub. No.: US 2010/0228567 A1
(43) Pub. Date: Sep. 9, 2010

(54) Medication Adherence System For And Method Of Facilitating An Automated Adherence Program

(75) Inventor: Stanley WULF, Berkeley, CA (US)

Correspondence Address: WILMERHALE/BOSTON, 60 STATE STREET, BOSTON, MA, 02109, US

(73) Assignee: INFOMEDICS, INC., Reading, MA (US)

(21) Appl. No.: 12/702,564

(22) Filed: Feb. 9, 2010

Related U.S. Application Data
(60) Provisional application No. 61/150,994, filed on Feb. 9, 2009.

(51) Int. Cl. G06Q 50/00

(52) U.S. Cl. 705/3

(57) ABSTRACT

A medication adherence system for and method of facilitating an automated adherence program is disclosed. The medication adherence system of the present disclosure may be, for example, a web-based and/or telephone-based system by which enrolled participants may access the automated adherence program. The medication adherence system may utilize an adherence application for assessing patients with respect to, for example, certain barriers and/or other adherence issues. Additionally, by use of adherence application, the content of the interactions between patients and the medication adherence system as well as the frequency and timing of the interactions is optimized with respect to the drop-off periods of medications. The adherence application may include, for example, an interactions routine for processing interactions content, a user interface, a feedback component, a drop-off algorithm, a patient assessment component that may further include a revealed barriers algorithm and a derived barriers algorithm. Further, the medication adherence system of the present disclosure provides a reporting mechanism.

### CROSS-REFERENCE TO RELATED APPLICATIONS

This application claims the benefit under 35 U.S.C. 119(e) of U.S. Provisional Patent Application No. 61/150,994, filed on Feb. 9, 2009 entitled “MEDICATION ADHERENCE SYSTEM FOR AND METHOD OF FACILITATING AN AUTOMATED ADHERENCE PROGRAM”, which is hereby incorporated by reference herein in its entirety.

### TECHNICAL FIELD OF THE DISCLOSURE

The present invention relates to systems and processes for improving medication adherence. In particular, this invention relates to a medication adherence system for and method of facilitating an automated adherence program.

### BACKGROUND OF THE DISCLOSURE

Using prescription drugs to treat ailments and illnesses is very common in modern medicine. In order to instruct patients of the need to regularly and consistently take prescription drugs, health care providers tell patients when to take prescribed dosages and pharmacists label the containers of prescription devices with the prescribed dosages and frequencies of taking the drugs. However, patients often fail to adhere to their prescribed dosage regimen, hampering the effectiveness of the prescription drug upon the patient and potentially putting the patient's health in jeopardy.

One reason for non-adherence is that patients often forget to take their prescription drugs. As a result, there are currently many adherence solutions that focus primarily on overcoming the problem of forgetfulness with respect to taking medication. For example, certain solutions may include visual and/or audible reminder devices that are incorporated in the prescription medicine containers. However, forgetfulness is but one reason for non-adherence. There are many other reasons that patients fail to adhere to prescribed dosage regimens, such as side effects, cost, complexity of the dosage regimen, inability to see the benefit of the drug, and difficulty in getting the prescription filled, to name a few. Consequently, focused adherence solutions, such as reminder devices, may be useful to a limited population of people that are non-adherent and do not address comprehensively the other reasons for non-adherence. Therefore, what is needed is a single comprehensive adherence solution that addresses several, and preferably all, of the reasons that patients fail to adhere to their prescribed medication dosage regimen.

Further, patients that are non-adherent, for any reason, may become dissatisfied with their physician and/or the prescribed medication. Therefore, what is needed are improved ways of interacting with patients that can lead to a higher degree of patient compliance, satisfaction with the prescribing physician and treatment, a greater likelihood of patient treatment adherence, and a higher degree of quality health outcomes.

Prescribing physicians often lack a robust feedback mechanism that allows them to understand how specific patients are adhering to prescription medication regimens. Typically, physicians schedule follow-up appointments for some period following prescription of medications to their patients. However, in many cases, it may benefit the physician to learn about patient adherence (or non-adherence) prior to the scheduled follow-up treatment, particularly in cases where the patient has a high likelihood of non-adherence to a prescribed treatment. This knowledge would allow the physician to intervene more quickly and provide a higher quality of care. Therefore, what is needed are improved physician feedback mechanisms with respect to prescription medication adherence programs.

### SUMMARY OF THE INVENTION

The present disclosure describes a medication adherence system for and method of facilitating an automated adherence program. The medication adherence system of the present disclosure may be, for example, a web-based and/or telephone-based system by which enrolled participants may access the automated adherence program. The medication adherence system may utilize an adherence software application for assessing patients with respect to, for example, certain barriers and/or other issues that may cause them to be partially or fully non-adherent to their specific prescription medication regimen. Based on the patient assessment, enrolled patients may interact with the medication adherence system via, for example, the Internet and/or telephone and receive, in an automated manner, content that may assist them to overcome the barriers causing the non-adherence. For example, at each interaction, the patient may be surveyed with respect to current adherence and/or other issues that may be causing some level of non-adherence. The frequency, timing, and content of the interactions between patients and the medication adherence system may be based on the patient assessments with respect to barriers and/or other issues and based on information about the prescribed medications (e.g., drop-off data). In particular, the content of the interactions and the frequency and timing of the interactions is optimized with respect to the drop-off period in order to achieve the greatest possible success with respect to achieving medication adherence.

An aspect of the medication adherence system of the present disclosure is that it provides a comprehensive solution to the problem of prescription medication non-adherence because it is content and issue based rather than tool and/or device based.

Another aspect of the medication adherence system of the present disclosure is that it provides a flexible solution because it has the ability to adjust to specific needs of the condition and medication and to adjust to drug-specific drop-off data.

Yet another aspect of the medication adherence system of the present disclosure is that it provides a mechanism for patient segmentation, such as, but not limited to, true behavior-based segmentation and segmentation based on revealed and derived barriers.

Still another aspect of the medication adherence system of the present disclosure is that it provides a feedback mechanism to physicians, that may have the effect of maximizing the physician's influence on the patient without requiring excessive commitment on the physician's part.

Embodiments of the invention are directed to a comprehensive solution to the problem of prescription medication non-adherence, because they are content and issue based (e.g., revealed and derived barriers) rather than tool and/or device based. Embodiments of the invention are flexible solutions, because they have the ability to adjust to specific needs of the condition and medication and to adjust to drug-specific drop-off data (e.g., using a drop-off algorithm). Embodiments of the invention can also include a mechanism for patient segmentation, such as, but not limited to, true behavior-based segmentation and segmentation based on revealed and derived barriers (e.g., using barriers, revealed barriers algorithm, and derived barriers algorithm of patient assessment component. Embodiments of the invention can also include a feedback mechanism to physicians, that may have the effect of maximizing the physician's influence on the patient without requiring excessive commitment on the physician's part.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 illustrates a functional block diagram of a medication adherence system, in accordance with the present disclosure;

FIG. 2 illustrates a functional block diagram of an adherence application of the medication adherence system, in accordance with the present disclosure;

FIGS. 3A and 3B illustrate examples of product adherence profiles that show plots of the drop-off periods of certain example medications;

FIG. 4 illustrates more details of the interactions content of the medication adherence system, in accordance with the present disclosure;

FIG. 5 shows a content mapping chart associated with the medication adherence system, in accordance with the present disclosure; and

FIG. 6 illustrates a flow diagram of a method of facilitating an automated adherence program by use of the medication adherence system, in accordance with the present disclosure.

FIG. 7 shows an example of a report that may be generated by the medication adherence system, in accordance with the present disclosure.

### DETAILED DESCRIPTION OF EMBODIMENTS OF THE INVENTION

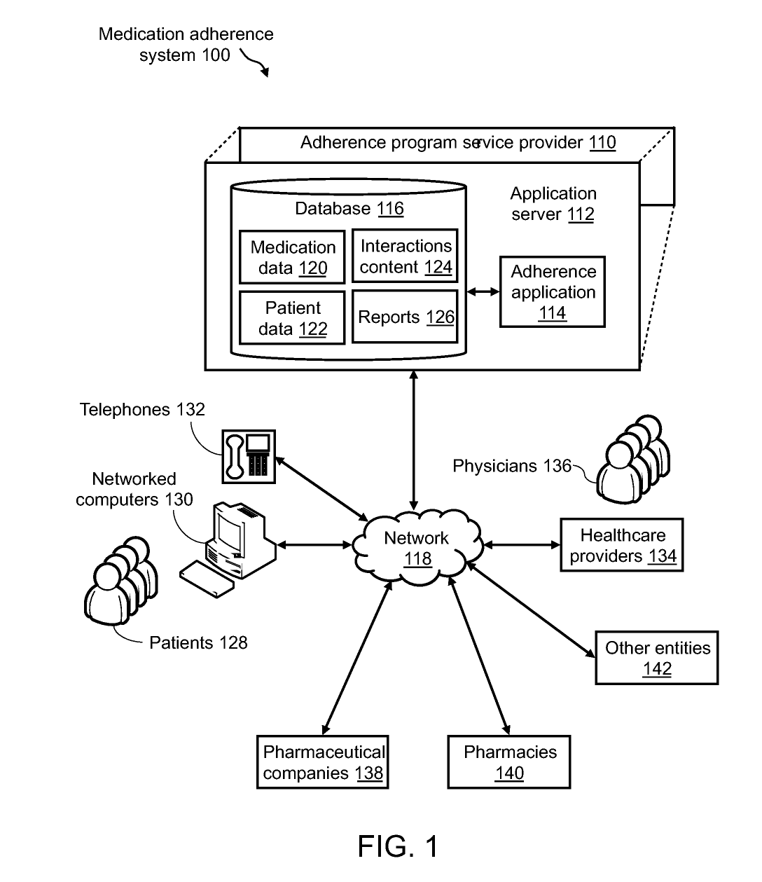

FIG. 1 illustrates a functional block diagram of a medication adherence system 100, in accordance with the present disclosure. Medication adherence system 100 includes an adherence program service provider 110, which is, for example, any company that is the owner and/or administrator of medication adherence system 100. An application server 112 of medication adherence system 100 may host an adherence application 114 and a database 116.

Application server 112 may be, for example, any centralized computing device that is suitable for hosting an application and that is suitable for communicating with other networked computing devices via a network 118. Application server 112 may be a Web server and/or an application server. Network 118 may be any network for connecting to the Internet, such as a wide area network (WAN) and/or local area network (LAN). Networked computers 130 of medication adherence system 100 may connect to network 118 in any wired and/or wireless fashion. Additionally, network 118 may be any telecommunications network, by which entities of medication adherence system 100 may exchange of information via telephones. Network 118 may be used to facilitate any exchange of information between any entities of medication adherence system 100.

Adherence application 114 is the software application that manages the overall operations of medication adherence system 100. In particular, adherence application 114 manages the overall operations of a web-based and/or telephone-based adherence program, including managing the patient interactions of the adherence program, navigation through the system, producing reports, and so on. In one example, the adherence program that is managed by adherence application 114 may be accessed with networked computers 130 via the Internet (via network 118) at a particular Web address of the website associated with medication adherence system 100. In another example, the adherence program that is managed by adherence application 114 may be accessed via telephones 132 by dialing a particular telephone number, such as a toll free telephone number associated with medication adherence system 100.

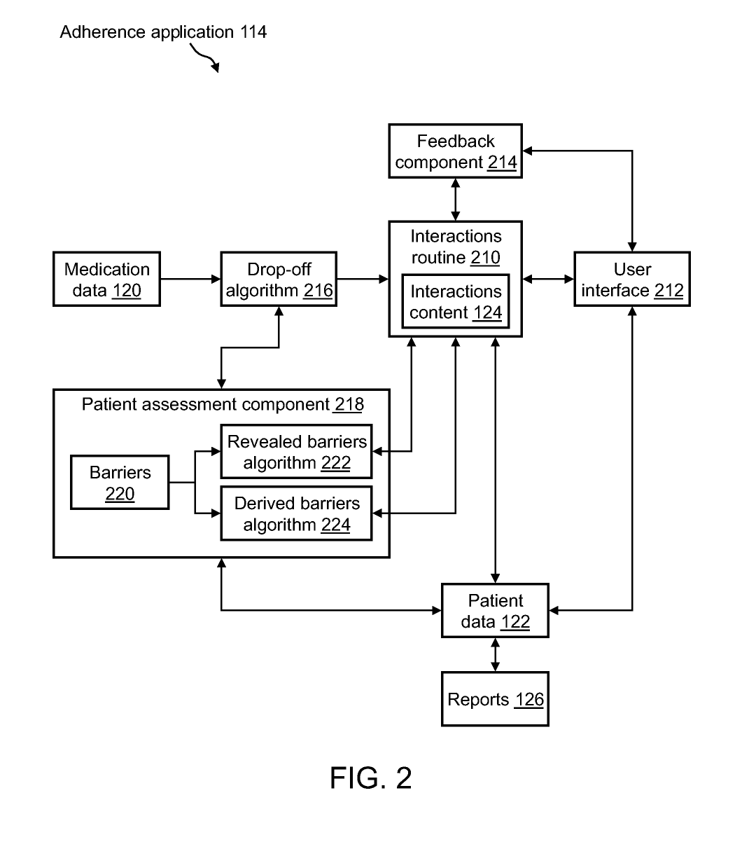

Database 116 may be created and maintained by any suitable database software, such as Oracle database software from Oracle Corporation (Redwood Shores, Calif.). Database 116 stores relationships between, for example, unique patient information, medication information, pharmaceutical companies (pharma) information, and/or other information. The contents of database 116 may be organized in any system-defined relational database structure. Database 116 stores any data that is related to adherence application 114, such as, but not limited to, medication data 120, patient data 122, interactions content 124, reports 126, and any other data. More details of adherence application 114 and the contents of database 116 are described with reference to FIGS. 2 through 7.

Multiple entities that are connected to application server 112 via network 118 may play a role in medication adherence system 100. For example, a plurality of patients 128 may be enrolled in the adherence program that is provided by medication adherence system 100. Each patient 128 may be a person that receives medical treatment from a prescribing physician for a specific medical indication. Patients 128 may also be individuals who are seeking assistance with respect to adhering to their prescription medication regimen. In particular, patients 128 may be enrolled in the adherence program of adherence application 114 in order to receive assistance to reduce, prevent, and/or otherwise overcome any tendency to be non-adherent with respect to their prescription medication regimens.

Patients 128 may access adherence application 114 of application server 112 via respective networked computers 130 that are connected to network 118. Each networked computer 130 may be any networked computer that has Internet browser capability. Additionally, patients 128 may access adherence application 114 via respective telephones 132.

Another entity of medication adherence system 100 may be a plurality of healthcare providers 134. Healthcare providers 134 may be, for example, doctor's offices, hospitals, clinics, and so on. A plurality of physicians 136 may be associated with healthcare providers 134. Physicians 136 may be physicians or other professionals who care for and (in the case of physicians or nurse practitioners) prescribe pharmaceuticals that may be manufactured by pharmaceutical companies 138 to patients 128. Physicians 136 may have access to adherence application 114 in order to access reports or other information that may be related to their patients 128 who are enrolled in and using medication adherence system 100.

Pharmaceutical companies 138 may be any of the manufacturers of the numerous pharmaceuticals that are available over the counter or by prescription for treating various indications (i.e., illness, disease, medical condition, or ailment). Examples of pharmaceutical companies 138 may include, but are not limited to, Bayer AG (Leverkusen, Germany) and Pfizer Inc. (New York, N.Y.).

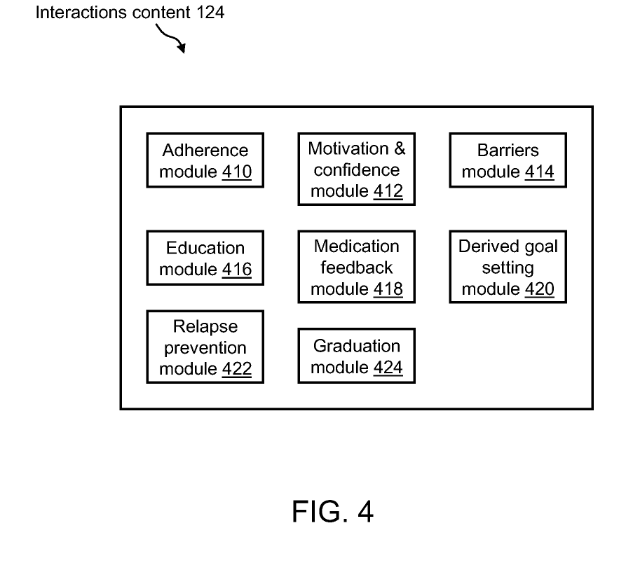

Pharmaceutical companies 138 may provide detailed information on any pharmaceuticals of interest to medication adherence system 100, which may be stored in medication data 120 of database 116. The pharmaceuticals information may include, but is not limited to, the pharmaceutical's name, ingredients, uses, disclaimers, expected results, possible side effects, dosage instructions, and so on. Further, this information may include medication-specific product adherence profile information. This is historical information that reflects the period of time after filling the prescription that patients have reduced and/or discontinued usage of the prescribed medication (i.e., become non-adherent). This product adherence profile information is hereafter referred to as “drop-off” data and this period of time is hereafter referred to as the “drop-off” period. More details of examples of product adherence profiles that illustrate the drop-off period are described with reference to FIGS. 4A and 4B.

Adherence application 114 may be used to assess patients with respect to, for example, certain barriers that may cause them to be partially or fully non-adherent to their specific prescription medication regimen. Based on the patient assessment, enrolled patients may interact with the medication adherence system 100 via, for example, the Internet and/or telephone and receive, in an automated manner, content that may assist them to overcome the barriers causing the non-adherence. The frequency, timing, and content of the interactions between patients and medication adherence system 100 may be based on the patient assessments and also based on the drop-off data of their specific prescription medication. In particular, adherence application 114 optimizes the content of the interactions and the frequency and timing of the interactions with respect to the drop-off period. In this way, the greatest possible success with respect to assisting patients to be adherent to their prescription medication regimens may be achieved.

Pharmacies 140 may be any pharmacies by which patients 128 may purchase medication over the counter and/or by prescription. Examples of pharmacies 140 may include, but are not limited to those that are operated by Rite Aid Corporation (Camp Hill, Pa.), CVS Corporation (Woonsocket, R.I.), and Walgreen Company (Deerfield, Ill.). Pharmacies 140 may provide information about prescriptions filled for patients 128 who are using medication adherence system 100. For example, when a certain patient has a prescription filled, this data may be transmitted from pharmacies 140 to application server 112 and stored in the corresponding record of patient data 122 of database 116.

Other entities 142 of medication adherence system 100 may include other professionals that may make recommendations to patients 128 regarding how to improve their adherence with respect to prescription medication regimens. Examples of other entities 142 may include, but are not limited to, dieticians, fitness trainers, and psychiatrists. Other entities 142 may also be a source of data to application server 112.

FIG. 2 illustrates a functional block diagram of adherence application 114 of medication adherence system 100 of the present disclosure. Adherence application 114 may include an interactions routine 210 for processing interactions content 124, a user interface 212, a feedback component 214, a drop-off algorithm 216, a patient assessment component 218 that may further include a compilation of barriers 220, a revealed barriers algorithm 222, and a derived barriers algorithm 224. Additionally, FIG. 2 shows that medication data 120 and patient data 122 are inputs to components of adherence application 114. Further, reports 126 is an example of an output of adherence application 114.

Interactions routine 210 of adherence application 114 is the mechanism for managing the interactions between patients 128 and medication adherence system 100. Interactions routine 210 also manages the link between interactions content 124 and user interface 212. In one example, user interface 212 may be a web-based graphical user interface (GUI) that is assessable by patients 128 via the web browsers of their networked computers 130. This web-based GUI (not shown) may be used by patients 128 to navigate through the operations of adherence application 114. In this example, interactions routine 210 is used to map the contents of interactions content 124 to the web-based GUI and to read in information that patients 128 may enter in certain entry fields of the web-based GUI.

In another example, user interface 212 may be a telephone menu system, such as an interactive voice response (IVR) system, which is assessable by patients 128 via telephones 132. In this example, interactions routine 210 is used to map the contents of interactions content 124 to a series of telephone-based menus. Patients 128 may navigate through these menus by pressing numbers on the keypads of their telephone 132 and/or by speaking numbers. When prompted, patients 128 may indicate responses also by pressing numbers on their telephone 132 and/or by speaking numbers.

Interactions content 124 processed by interactions routine 210 may be a quantity of predetermined content designed to assist, encourage, and/or guide patients 128 with respect to adhering to their prescription medication regimens. For each patient 128, interactions content 124 may be organized in a patient- and medication-specific manner and then presented to the patient 128 in a manner that is optimized to achieve the greatest possible success with respect to assisting the patient 128 to be adherent to his/her prescription medication regimen. Interactions content 124 may be compiled in one or more content area modules. More details of the various module of interactions content 124 are described with reference to FIG. 4.

Feedback component 214 of adherence application 114 is the mechanism for processing patient responses during interactions between patients 128 and medication adherence system 100 and providing relevant feedback to patients 128 that corresponds to their responses. This feedback is designed to assist, encourage, and/or guide patients 128 with respect to adhering to their prescription medication regimens. Feedback that is generated by feedback component 214 does not result in adjusting the interactions content 124 that is presented in current or subsequent interactions. This feedback is intended to support the interaction and to provide further influence to patients 128, leading toward improved adherence.

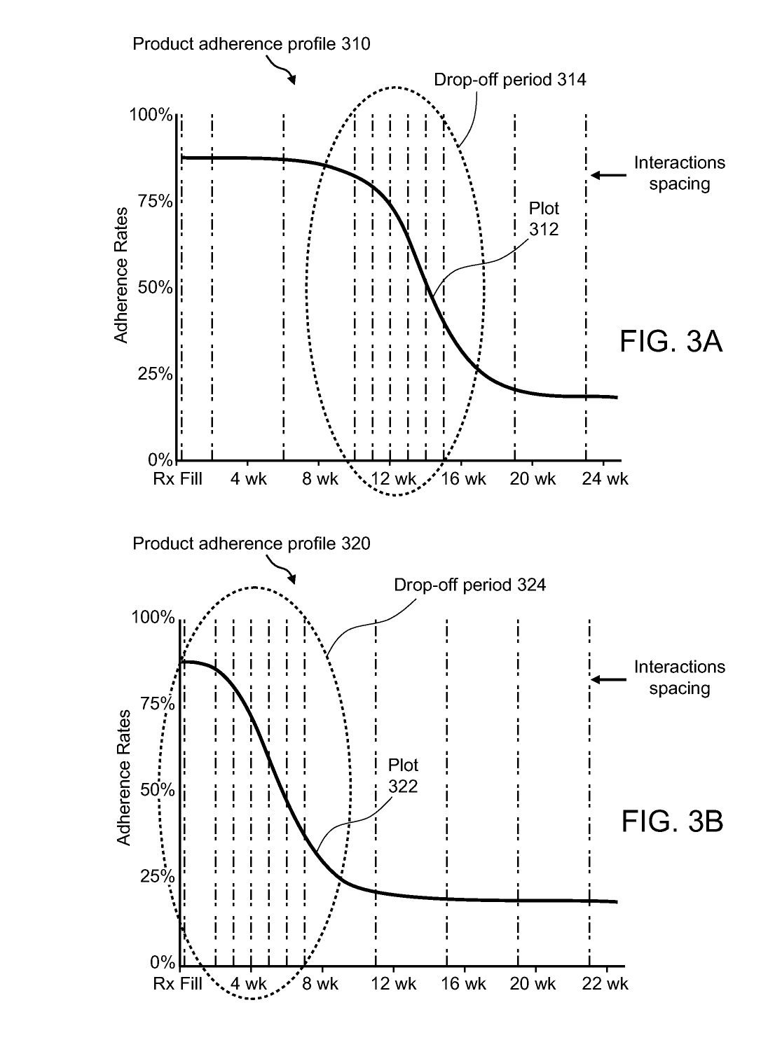

Drop-off algorithm 216 of adherence application 114, which is fed by medication data 120, may be used to analyze medication data 120 in order to determine the drop-off period for any medications of interest. For example, for a certain medication of interest, drop-off algorithm 216 may read in the product adherence profile of the certain medication of interest from medication data 120 and then determine its drop-off period. More details of examples of product adherence profiles that may be found in medication data 120 are described with reference to FIGS. 3A and 3B.

FIGS. 3A and 3B illustrate product adherence profiles 310 and 320, respectively, which are examples of product adherence profiles that show plots of the drop-off periods of certain example medications.

Referring to FIG. 3A, product adherence profile 310 shows a plot 312 of the percent (%) adherence rates vs. time (beginning at the date the prescription is filled), which is the product adherence profile for a first example medication of interest. For example, plot 312 spans a period of 24 weeks from the date the prescription is filled. In this example, a drop-off period 314 is identified from about week 8 to about week 16, with the maximum drop-off point at about week 13 of plot 312. The maximum drop-off point is the point with maximum slope on a drop-off curve. The drop off curve can be generated by tracking, starting from a patient filling their first prescription, when a patient become non-adherent. By tracking this for a population of patients a drop-off curve can be generated.

Referring to FIG. 3B, product adherence profile 320 shows a plot 322 of the percent (%) adherence rates vs. time (beginning at the date the prescription is filled), which is the product adherence profile for a second example medication of interest. For example, plot 322 spans a period of 24 weeks from the date the prescription is filled. In this example, a drop-off period 324 is identified from about the date the prescription is filled to about week 8, with the maximum drop-off point at about week 5 of plot 322.

Referring again to FIG. 2, after analyzing the product adherence profile and determining the drop-off period for a certain medication, drop-off algorithm 216 of adherence application 114 then determines the recommended frequency and timing of the interactions between patients 128 and medication adherence system 100, wherein the frequency and timing of the interactions is concentrated at the drop-off period of the certain drug. Because the drop-off periods may occur at different times for different medications, the recommended frequency and timing of the interactions, as determined by drop-off algorithm 216, may differ from one medication to another. The variable interactions is an example of the flexibility that is built into medication adherence system 100, in that the frequency and timing of the interactions is adjusted according to the drop-off periods.

Generally, drop-off algorithm 216 finds the maximum drop-off point for a certain drug and then determines the timing and frequency of the interactions around this point. More specifically, the interactions are maximized just prior to and during the maximum drop-off point of the medication of interest. For example, three interactions spaced one week apart may be recommended immediately prior to the maximum drop-off point, one interaction recommended at the maximum drop-off point, two interactions spaced one week apart are recommended immediately following the maximum drop-off point, and interactions spaced every 4 weeks outside of these focused interactions. The result is that six interactions are concentrated at or near the drop-off period. For any medication of interest, drop-off algorithm 216 applies the aforementioned criteria in order to determine its recommended interaction timing and frequency within the adherence program of medication adherence system 100. For a certain medication of interest, the recommended interaction timing and frequency may be the same for all patients 128 that have been prescribed this certain medication and that are enrolled in the adherence program. In other words, drop-off algorithm 216 may be executed once for each respective brand, type, and/or class of medication. The respective results of drop-off algorithm 216 may then be used in common for each respective group of patients 128 using each respective brand, type, and/or class of medication.

In one example and referencing product adherence profile 310 of FIG. 3A, the maximum drop-off point is at about week 13 and, thus, drop-off algorithm 216 determines that the interactions should take place at the date the prescription it filled; week 10, 11, 12, 13, 14, and 15; and spaced every 4 weeks prior to week 10 and following week 15.

In another example and referencing product adherence profile 320 of FIG. 3B, the maximum drop-off point is at about week 5 and, thus, drop-off algorithm 216 determines that the interactions should take place at the date the prescription it filled; week 2, 3, 4, 5, 6, and 7; and spaced every 4 weeks following week 7.

The programming of drop-off algorithm 216 is not limited to determining the timing and frequency of six interactions at or near the drop-off period of a certain medication. Drop-off algorithm 216 may be programmed to determine the timing and frequency of any number of interactions that may be useful in the adherence program of medication adherence system 100.

Further, for each respective brand, type, and/or class of medication, drop-off algorithm 216 determines the recommended frequency and timing of the interactions between patients 128 and medication adherence system 100 and feeds this information into interactions routine 210. Subsequently, the interactions content 124 that is presented to patients 128 during the interactions, which are determined by drop-off algorithm 216, is dependent on the brand, type, and/or class of medication and also on the outcome of the patient assessment component 218 of adherence application 114 for respective patients 128.

Compiled in patient assessment component 218 are certain barriers 220. Barriers 220 may be any barriers or reasons that contribute to patients 128 being non-adherent to their prescription medication regimens. Example of barriers 220 may include, but are not limited to, the following.
1. forgetfulness;
2. side effects;
3. patient not being able to see the benefit of the medication (i.e., mistrust of the drug);
4. patient does not understand the reasons for taking the medication, which may be the result of poor doctor-patient communication;
5. taking the medication is a reminder of the illness to patients (i.e., denial of the condition);
6. difficulty in getting the prescription filled (e.g., poor mobility, not convenient);
7. complexity of the regimen (e.g., 4 times a day with food); and
8. cost of the medication.

For certain medications, other barriers may be identified from medication data 120. For each patient 128, patient assessment component 218 is used to determine any and all barriers 220 that apply. Additionally, for each barrier 220 that applies, patient assessment component 218 is used to further classify the barrier as a “revealed” barrier (or solicited barrier) or a “derived” barrier.

A revealed barrier means any barrier that is openly acknowledged by the patient. For example, for certain patients 128, forgetfulness, side effects, difficulty in getting the prescription filled, and cost may be revealed barriers. Revealed barriers algorithm 222 may be used to determine and log revealed barriers of respective patients 128. For example, revealed barriers algorithm 222 may manage and interpret certain automated questionnaires and/or surveys to be taken by patients 128 using user interface 212. These questionnaires and/or surveys may include direct questions to patients 128, such as “Have you had problems with . . . . ”

A derived barrier means any barrier that is not openly acknowledged by the patient and, therefore, must be determined by other means. For example, for certain patients 128, derived barriers, such as denial of the condition, mistrust of the drug, and communication problems with the physician, are harder to deduce. Confidence level, motivational level, and previous medication behaviors may yield derived barriers. Therefore, derived barriers algorithm 224 may be used to determine and log revealed barriers of respective patients 128. For example, derived barriers algorithm 224 may manage and interpret certain automated questionnaires and/or surveys to be taken by patients 128 using user interface 212. In particular, using derived barriers algorithm 224, behavioral questioning reveals three primary segmentation factors: (1) confidence, (2) motivation, and (3) previous adherence patterns. Associated questionnaires and/or surveys may include less direct questions to patients 128, such as “Many people like you find that they are not sure why this kind of medication is needed . . . ”

With respect to the three primary segmentation factors: (1) confidence, (2) motivation, and (3) previous adherence patterns, derived barriers algorithm 224 may further categorize patients 128 into one or more sub-groups. For example, patients 128 may be characterized as having . . . .
high motivation, low confidence, poor past adherence,
low motivation, medium confidence, good past adherence,
medium motivation, high confidence, poor past adherence,
medium motivation, high confidence, good past adherence, and so on.

For each sub-group, certain barriers are more likely than others. For example, if a patient 128 has “low motivation,” barriers that are more likely to be a problem may be, for example, side effects or not being able to see the benefits. Therefore, at the end of the comprehensive assessment that is performed by use of patient assessment component 218, each patient 128 is essentially “labeled” with a certain set of barriers. As a result, the sub-groups may result in corresponding custom pathways in the adherence program for managing various combinations of both revealed and derived barriers. The custom pathways also allow adherence application 114 to provide enhanced comparative feedback and personalized goal setting.

The comprehensive assessment that is performed by use of patient assessment component 218 may occur during one or more initial interactions of the adherence program. Further, at the end of the comprehensive assessment, the results are used to inform interactions routine 210. In this way, interactions routine 210 is directed as to the presentation of relevant interactions content 124 for the interactions that are concentrated at or near the drop-off period, whose frequency and timing is determined by drop-off algorithm 216.

The assessment process that may be performed by patient assessment component 218 of adherence application 114 is an example mechanism for performing patient segmentation, such as, but not limited to, true behavior-based segmentation and segmentation based on revealed and derived barriers.

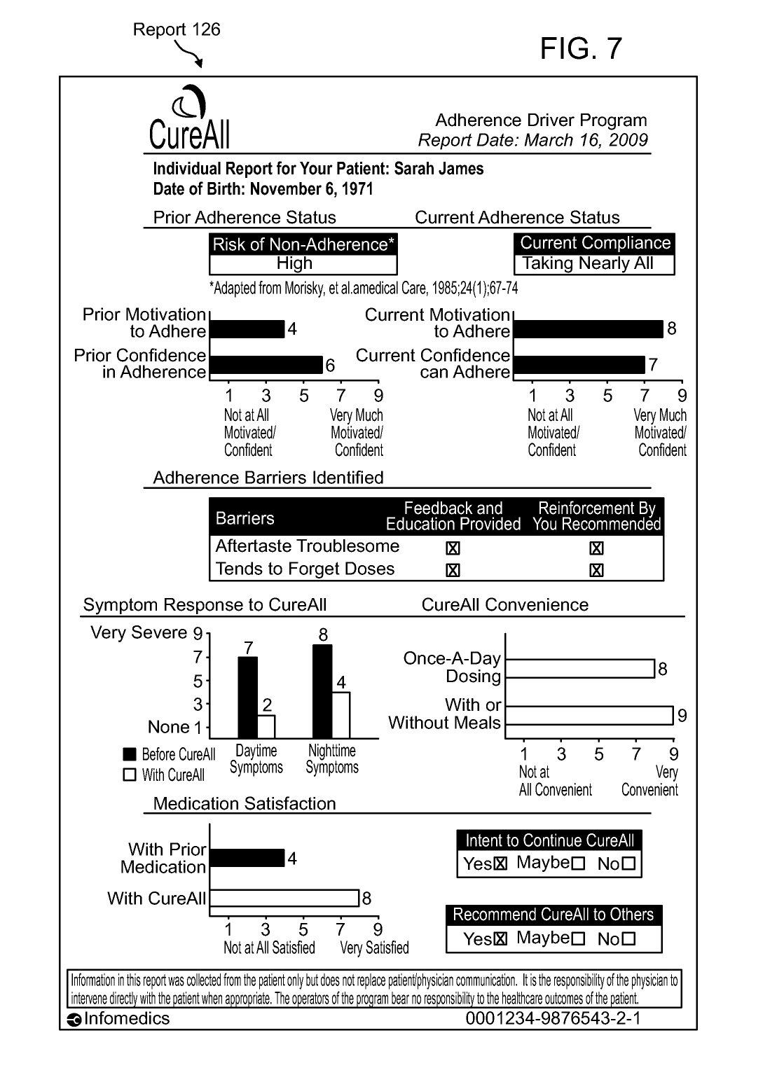

Throughout the interactions that occur between patients 128 and medication adherence system 100, patient data 122 may be continuously updated with patient responses and/or other information. Interactions routine 210 may be continuously informed by patient data 122. As a result, the presentation of interactions content 124 and feedback from feedback component 212 may be modified dynamically. For example, when a patient 128 indicates that a certain barrier has been overcome, content about this barrier may be reduced and/or eliminated from future interactions. Furthermore, reports 126 may be generated based on patient data 122 at defined intervals throughout the adherence program in order to inform the physicians 136 of patients 128. Report 126 is an example of a feedback mechanism to physicians, which may have the effect of maximizing the physician's influence on the patient without requiring excessive commitment on the physician's part. An example of a report 126 is found with reference to FIG. 7.

FIG. 4 illustrates more details of interactions content 124 of medication adherence system 100 of the present disclosure. Interactions content 124 may include certain software and/or information modules, such as, but not limited to, an adherence module 410, a motivation and confidence module 412, a barriers module 414, an education module 416, a medication feedback module 418, a derived goal setting module 420, a relapse prevention module 422, and a graduation module 424.

Adherence module 410 may be a collection of information about certain adherence issues. The information of adherence module 410 may be used to document the patient's prior adherence history and tendencies, monitor current adherence, and provide feedback to the patient about how he/she is progressing. The contents of adherence module 410 may also include support information for patients 128 who have not initiated their medication.

Motivation and confidence module 412 may be a collection of information about the two main factors that are monitored with respect to behavior change—motivation and confidence, which are the main behavioral elements that drive revealed barriers algorithm 222 and derived barriers algorithm 224.

Barriers module 414 may be a collection of information about barriers, such as the revealed barriers and derived barriers. The contents of barriers module 414 may also include feedback and support information for patients about their identified barriers.

Education module 416 may be a collection of educational information on the patient's condition and specific medication and any other educational support information.

The patient's satisfaction with his/her medication may have an effect on their adherence. The more satisfied, the more likely a patient will be adherent. While medication feedback module 418 may not be specific to adherence, the information therein may be used to determine how the patient's response to his/her medication is being perceived by that patient. The contents of medication feedback module 418 may be used to acquire the patient's opinion on how well it is working and on how easy it is to use.

Derived goal setting module 420 may be a collection of information about goals, thereby supporting another behavioral element. The contents of derived goal setting module 420 may be used to present to the patient one or more obtainable goals that can be achieved, preferably, by the next interaction.

Relapse prevention module 422 may be a collection of information about relapse prevention, thereby supporting another behavioral element. The contents of relapse prevention module 422 may be particularly useful toward the end of the interactions to provide education about relapse prevention. This is because no matter how far along the medication regimen the patient may be, there is always a risk of relapse. Therefore, when presented with relapse prevention information, the patient may realize certain relapse behavior, and may be assisted in order to interrupt and/or prevent relapse.

Graduation module 424 may be a collection of information about the progress of the patient, which is typically presented near or at the end of the adherence program. For example, the contents of graduation module 424 may provide feedback to the patient on how well they have done, e.g., “Well done. Keep going.” or “You've shown some improvement, but there is more work to be done.” Further, the contents of graduation module 424 may provide information on what the patient's next steps may be.

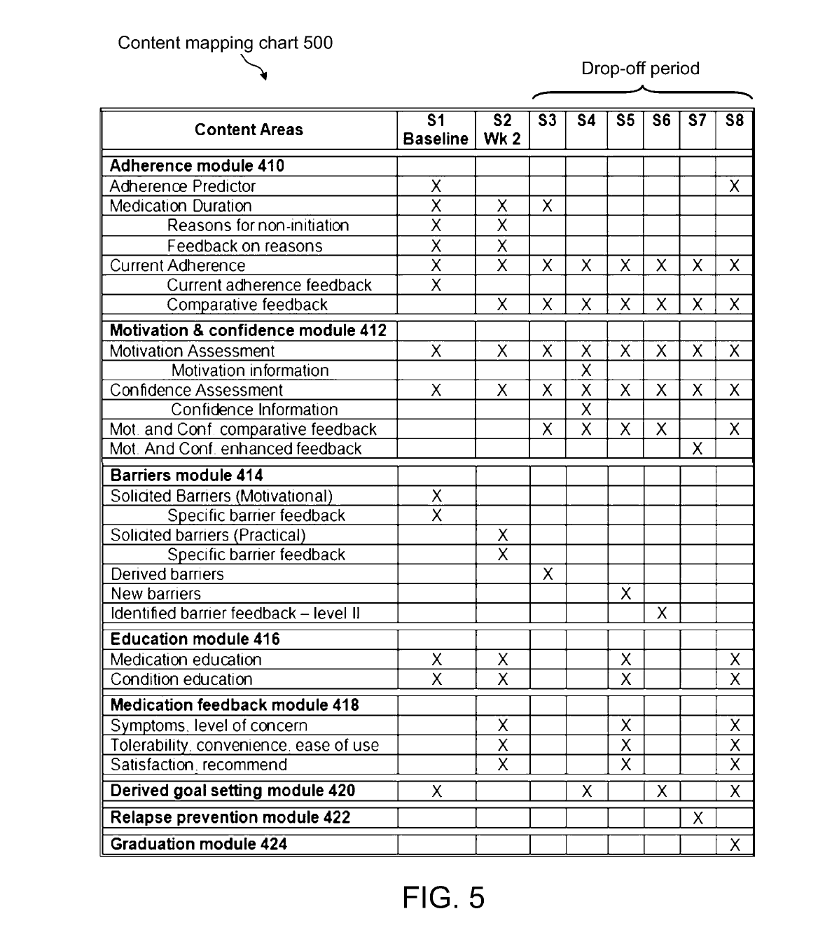

Certain content of the various content modules is presented to patients 128 during the interactions, which have predetermined timing and frequency. The specific content that is presented and the timing of the content may be based on the comprehensive assessment of patient assessment component 218 and based on current information that is received from patients 128 during each interaction. An example of the timing at which the information of the various content modules is presented to patients 128 with respect to the multiple interactions is shown in FIG. 5.

FIG. 5 shows a content mapping chart 500 that is associated with medication adherence system 100 of the present disclosure. Content mapping chart 500 is one example of a content mapping chart. Medication adherence system 100 is not limited to the contents of content mapping chart 500 only.

Content mapping chart 500 shows multiple sessions (e.g., S1 through S8) that are associated with multiple interactions, respectively, between patients 128 and medication adherence system 100. In the case of a Web-based user interface 212, the sessions (e.g., S1 through S8) refer to computer sessions using the Internet. In the case of a telephone-based user interface 212, the sessions (e.g., S1 through S8) refer to telephone sessions. In either case, each session involves the patient 128 accessing medication adherence system 100, which may include an authentication process, the patient 128 assessing content of medication adherence system 100, and the patient 128 providing information to medication adherence system 100.

S1 of content mapping chart 500 is the initial session of the adherence program that may occur at or near the date of beginning the prescription medication regimen (i.e., when the patient 128 fills the prescription). S2 may occur, for example, at about week 2 of the adherence program. The adherence program is designed for S1 and S2 to occur regardless of the variability in patient assessment. This is because the presentation of information in adherence module 410 and education module 416 is particularly useful and important in these times.

S3 through S8 refer to, for example, the six interactions that are concentrated at or near the drop-off period of a certain medication. As a result, the actual occurrence in time of S3 through S8 may vary depending on the timing that is determined by drop-off algorithm 216. In one example and referring again to FIG. 3A, S1 may correspond to week 0, S2 may correspond to week 2, and S3 through S8 may correspond to weeks 10 through 15, respectively. In another example and referring again to FIG. 3B, S1 may correspond to week 0, S2 may correspond to week 1, and S3 through S8 may correspond to weeks 2 through 7, respectively.

Referring again to content mapping chart 500 of FIG. 5, an “X” indicates the mapping between information of the content areas (i.e., content modules) and the multiple sessions (e.g., S1 through S8). For example, the “medication duration” information of adherence module 410 is presented at S1, S2, and S3 and not presented at S4, S5, S6, S7, and S8; whereas the “current adherence” information of adherence module 410 is presented at S1, S2, S3, S4, S5, S6, S7, and S8; and so on.

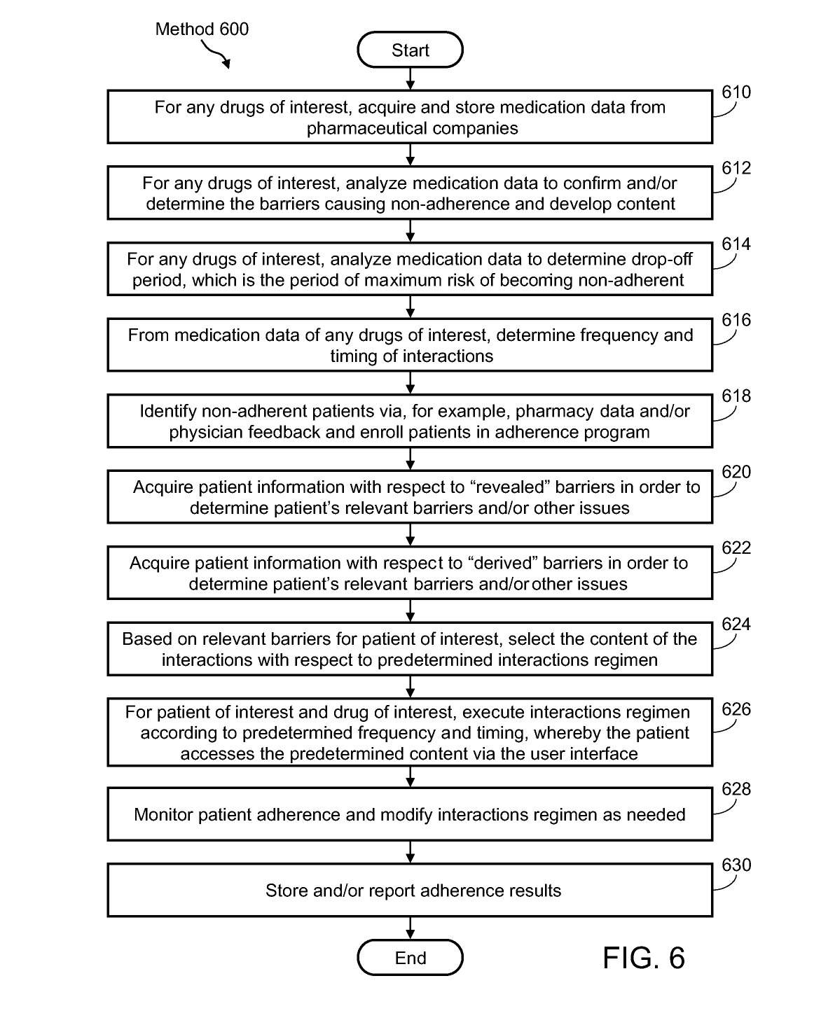

FIG. 6 illustrates a flow diagram of a method 600 of facilitating an automated adherence program by use of medication adherence system 100, in accordance with the present disclosure. Method 600 may include, but it not limited to, the following steps, which are not limited to the following order.

At step 610, for any drugs of interest, acquire and store medication data from the pharmaceutical companies. For example, for any brand, type, and/or class of medication the respective medication data is acquired from its manufacturer and/or supplier (e.g., pharmaceutical companies 138) and stored in medication data 120 of database 116 at application server 112.

At step 612, for any drugs of interest, the corresponding information in medication data 120 may be analyzed by patient assessment component 218 in order to confirm and/or determine the barriers causing non-adherence. Subsequently, content related to barriers and/or any other issues may be developed for use in the adherence program that is supported by medication adherence system 100 of the present disclosure. This content may be organized in the various content modules of interactions content 124, as described with reference to FIG. 4.

At step 614, for any drugs of interest, drop-off algorithm 216 is used to analyze medication data 120 in order to determine the corresponding drop-off periods, which are the periods of maximum risk of becoming non-adherent. For example, drop-off algorithm 216 may analyze product adherence profiles of any drugs of interest in order to determine the corresponding drop-off periods, as described with reference to FIGS. 3A and 3B.

At step 616, using medication data 120 of any drugs of interest, drop-off algorithm 216 is used to determine frequency and timing of the interactions. In one example, drop-off algorithm 216 determines six interactions that are concentrated at or near the drop-off period, as described with reference to FIGS. 2, 3A, and 3B.

At step 618, non-adherent patients may be identified via, for example, pharmacy data from pharmacies 140 and/or feedback from healthcare providers 134 and/or physician 136. Subsequently, patients 128 may be invited, for example, by their physicians 136 to enroll in the adherence program that is supported by medication adherence system 100 of the present disclosure.

At step 620, patient information may be acquired with respect to “revealed” barriers in order to determine patient's relevant barriers. For example and referring to content mapping chart 500 of FIG. 5, content from barriers module 414 may be presented to the patient during the initial sessions (e.g., S1, S2, and/or S3) and revealed barriers algorithm 222 of patient assessment component 218 may be used to process the patient information (e.g., responses to survey questions) in order to determine patient's relevant barriers and/or other issues with respect to medication adherence.

At step 622, patient information may be acquired with respect to “derived” barriers in order to determine patient's relevant barriers. For example and referring to content mapping chart 500 of FIG. 5, content from barriers module 414 may be presented to the patient during the initial sessions (e.g., S1, S2, and/or S3) and derived barriers algorithm 224 of patient assessment component 218 may be used to process the patient information (e.g., responses to survey questions) in order to determine patient's relevant barriers and/or other issues with respect to medication adherence.

At step 624, based on relevant barriers for the patient of interest, the content of the interactions with respect to predetermined interactions regimen is selected. For example, based on relevant barriers for the patient of interest, the relevant content to be presented to the patient at each interaction is selected from the content modules of interactions content 124.

At step 626, for the patient of interest and the drug of interest, interactions regimen is executed according to the predetermined frequency and timing, whereby the patient accesses the predetermined content via the user interface. For example, a certain patient 128 accesses medication adherence system 100 via user interface 212, which may be, for example, Web-based and/or telephone-based, and assesses the content according to the predetermined frequency and timing, whereas the content targets the patient's relevant barriers and/or other issues with respect to medication adherence. Additionally, feedback from feedback component 214 is provided to patents 128 throughout the interactions of the adherence program. Feedback component 214 accesses the content modules (FIG. 4) for its feedback information.

Continuing step 626, further illustrating the interactions regimen, APPENDIX A provides an example of the program flow of certain interactions (sessions) that are executed in the adherence program that is supported by medication adherence system 100 of the present disclosure. The program flow of APPENDIX A is an example of using a telephone-based user interface 212. Further, the program flow of APPENDIX A shows an example of feedback that is provided to patients and patient assessment that is based on patient responses to survey questions.

At step 628, patient adherence is monitored and the interactions regimen may be modified as needed depending on input from the patient of interest. For example, throughout the interactions of the adherence program, information is collected from patients 128, which may be monitored by interactions routine 210 and/or patient assessment component 218 in order to determine the progress of patients 128. The content that is presented to patients 128 may be modified (from the original planned content) depending on patient responses. For example, when a patient 128 indicates that a certain barrier has been overcome, content about this barrier may be reduced and/or eliminated from future interactions.

At step 630, throughout the interactions of the adherence program that is supported by medication adherence system 100, patient data 122 is collected and stored. At any defined intervals throughout adherence program, reports 126 may be generated. Reports 126 may be useful for informing patients 128, physicians 136, pharmaceutical companies 138, pharmacies 140, and/or any other entities 142.

FIG. 7 shows an example of a report 126 that may be generated by medication adherence system 100 of the present disclosure. In this example, report 126 shows information about the patient's adherence progress and medication experience that is presented in a manner that is easily interpreted by, for example, the patient and the patient's physician.

Physician involvement and the feedback loop that reports 126 provide is an important aspect of medication adherence system 100 of the present disclosure. This is because (1) physicians may be the prime motivator for patient participation, (2) reports 126 provide medication and adherence information as a true value add, (3) information of reports 126 may be a positive influence on the physician's view of the medication and associated pharmaceutical company, and (4) information of reports 126 may increase the medication profile in the office, which may result in increased adherence support and NRx spillover effect. Doctors who are positively influenced by the report will tend to prescribe the drug to patients other than the ones in the program, increasing NRx—new drug prescriptions.

### APPENDIX A

### Third Session

### Core Clinical Content Only

If 2^{nd} Session Duration=‘not started’ GOTO Medication Duration Module.

### Else go to Adherence Module

### Medication Duration Module

When we talked last time, you had not yet started taking CureEx.
Have you started taking it since then?
If Yes, Press 1 now
If No, Press 2 now
If Yes,
Great.
   GOTO Adherence Module
If No,
It's been for some time now that you've been telling me that you haven't started CureEx.
Please discuss this with your doctor, and if you do start, come back and let us know how you're doing. Hope to hear from you soon. (terminate session)

### Medication Adherence Module

How regularly have you been taking CureEx?
If you've been taking every dose as directed, press 1.
If nearly every dose, press 2.
If most doses, press 3.
If half or less of the doses, press 4.
If you have not been taking CureEx, press 5.
To hear the choices again, press 6.

### Change in Adherence Feedback

| Adherence Level | | | | |
|---|---|---|---|---|
| Last | This | | | |
| Session | Session | Response | | GOTO |
| All | All | A1 | Great, you've continued taking CureEx | Motivation/Confidence |
| | | | as prescribed. Keep up the good work | |
| | Almost | A2 | Seems like you're taking less of your | Motivation/Confidence |
| | | | CureEx than last time we talked. I hope | |
| | | | this is a temporary situation and you'll | |
| | | | get back to taking your CureEx as | |
| | | | prescribed. If you have any concerns do | |
| | | | talk to your doctor about them soon. | |
| | Most | A3 | A2 | Motivation/Confidence |
| | ≦Half | A4 | A2 | Motivation/Confidence |
| | None | A5 | Sounds like you've stopped taking | Q1 below (‘Have you |
| | | | CureEx. | and doctor decided to |
| | | | | stop?’) |
| Almost | All | B1 | This is great! You're now taking your | Motivation/Confidence |
| | | | CureEx as prescribed and will get the | |
| | | | most benefit from it. Keep up the good | |
| | | | work. | |
| | Almost | B2 | It's good that you continue to take | Motivation/Confidence |
| | | | almost all your CureEx. Perhaps by | |
| | | | trying some of the suggestions I'll give | |
| | | | you a bit later in this call, you can start | |
| | | | taking it exactly as prescribed. | |
| | Most | B3 | Seems like you're taking less of your | Motivation/Confidence |
| | | | CureEx than last time we talked. I hope | |
| | | | this is a temporary situation and you'll | |
| | | | work on getting back to taking at least | |
| | | | as much as you were taking. If you | |
| | | | have any concerns do talk to your doctor | |
| | | | about them soon. | |
| | ≦Half | B4 | B3 | Motivation/Confidence |
| | None | B5 | A5 | Q1 below (‘Have you |
| | | | | and doctor decided to |
| | | | | stop?’) |
| Most | All | C1 | B1 | Motivation/Confidence |
| | Almost | C2 | It's great you're now taking almost all | Motivation/Confidence |
| | | | your CureEx as prescribed. Keep up the | |
| | | | good work and eventually you'll be | |
| | | | taking it exactly as prescribed. | |
| | Most | C3 | I'm glad to hear you're still taking most | Motivation/Confidence |
| | | | of your CureEx. Perhaps some of the | |
| | | | suggestions I'll give you in a moment | |
| | | | will make it easier to take it as | |
| | | | prescribed. | |
| | ≦Half | C4 | Sounds like you're taking even less | Motivation/Confidence |
| | | | CureEx than you were taking. I wonder | |
| | | | why? Do talk to your doctor soon about | |
| | | | any concerns you have soon. I hope | |
| | | | some of the suggestions I'll give you in | |
| | | | a moment will make it easier to take it | |
| | | | as prescribed. | |
| | None | C5 | A5 | Q1 below (‘Have you |
| | | | | and doctor decided to |
| | | | | stop?’) |
| ≦Half | All | D1 | B1 | Motivation/Confidence |
| | Almost | D2 | C2 | Motivation/Confidence |
| | Most | D3 | It's great you're taking more of your | Motivation/Confidence |
| | | | CureEx than you were last time we | |
| | | | talked. Keep up the good work and | |
| | | | perhaps you'll soon be taking all of it | |
| | | | and getting the full benefit. Perhaps | |
| | | | some of the suggestions I'll give you in | |
| | | | a moment will make it easier to take it | |
| | | | as prescribed. | |
| | ≦Half | D4 | If this is 3^{rd} time here, | Motivation/Confidence |
| | | | You continue to tell me that you are | |
| | | | taking not more than half your | |
| | | | prescribed CureEx. I wonder if this | |
| | | | concerns you, as I am concerned that | |
| | | | you're not getting the full benefit of | |
| | | | CureEx. I have more suggestions for | |
| | | | you today, but if you haven't already, I | |
| | | | want to strongly encourage you to | |
| | | | discuss this with your doctor. | |
| | | | Else, | |
| | | | Seems like you continue to take only | |
| | | | some of your CureEx, and therefore you | |
| | | | will not get the full benefit from this | |
| | | | medication. Perhaps some of the | |
| | | | suggestions I'll give you in a moment | |
| | | | will make it easier for you to start taking | |
| | | | it as prescribed. | |
| | None | D5 | A5 | Q1 below (‘Have you |
| | | | | and doctor decided to |
| | | | | stop?’) |
| None | All | E1 | Wow! You've gone from not taking any | Motivation/Confidence |
| | | | of your CureEx the last time we talked | |
| | | | to taking it as prescribed. This is great, | |
| | | | and will mean you'll get the full benefit | |
| | | | of this medication. Keep up the good | |
| | | | work. | |
| | Almost | E2 | Great! You've gone from not taking any | Motivation/Confidence |
| | | | of your CureEx to taking almost all of it. | |
| | | | Keep up the good work, and perhaps | |
| | | | you'll be taking all of it soon. | |
| | Most | E3 | I'm glad to hear that you're now taking | Motivation/Confidence |
| | | | most of your CureEx, because last time | |
| | | | you told me you weren't taking any of | |
| | | | it.. Keep increasing how much of your | |
| | | | CureEx you take and soon you'll get the | |
| | | | full benefit of this medication. | |
| | ≦Half | E4 | It's good that you're now taking some of | Motivation/Confidence |
| | | | your CureEx since last time you told me | |
| | | | you weren't taking any of it. But to | |
| | | | really get the full benefit you need to | |
| | | | take it as prescribed. Perhaps some of | |
| | | | the suggestions I'll give you in a | |
| | | | moment will make it easier to take your | |
| | | | CureEx. | |
| | None | E5 | A5 | Q1 below (‘Have you |
| | | | | and doctor decided to |
| | | | | stop?’) |

Q1: Have you and your doctor decided that you would stop taking CureEx?
If Yes, press 1, If No, press 2.
   If 1,
      We appreciate your interest in this program, but it's for those taking CureEx. If you and your doctor decide to start CureEx, please call us back again. Once again, many thanks for your interest. Bye for now.
   If 2,
      If you haven't already done so, please speak to the doctor about why you are not taking CureEx. Also, review the information received as part of this program—there will probably be information to help you understand more about the benefits of CureEx for you and why your doctor prescribed it [Add specifics when available]. I also encourage you to continue with today's call to learn more about CureEx and how to better take medications as prescribed.

### Motivation/Confidence Module

Now, let me ask you again how motivated and confident you are about taking CureEx.

Motivation Assessment
How motivated are you to take CureEx as prescribed?
Choose any number from 1 to 9, with 1 being not at all motivated and 9 being very motivated
If answered 1-5, consider LOW motivation
If answered 6-9, consider HIGH motivation

Confidence Assessment
How confident are you that you can take your CureEx as prescribed from now on?
Choose any number from 1 to 9, with 1 being not at all confident and 9 being very confident.
If answered 1-5, consider LOW confidence
If answered 6-9, consider HIGH confidence

### Feedback:

If M and C both equal 5 or 6 (So both medium)
So both your Motivation and Confidence are in the middle of the range. These feelings often go hand in hand. When motivation goes up, most people feel that they will put more into taking their medication as prescribed, and therefore they are more confident they will succeed.
If adherence “half or less”,
It's likely that the reason you've been taking so little of your CureEx has something to do with your confidence and motivation.
If adherence “none”,
It's likely that the reason you've not been taking your CureEx has something to do with your confidence and motivation.
Everyone,
Are there reasons that your motivation is not higher? Can you talk to your doctor about them? Perhaps hearing more about issues that are known to lower a person's motivation to take a medicine will help.
Go to Barriers1

### If M=HIGH and C=HIGH

It's great you are both quite motivated and confident about taking CureEx as prescribed. It means it is likely you'll be successful with this medication. Perhaps some more ideas about issues that can get in the way will help you continue to feel this way.
Go to Barriers2

### If M=HIGH and C=LOW

So your motivation is higher than your confidence. It is true—even when we want to do something, it isn't always easy. And perhaps you know from how it's been for you in the past that this isn't easy for you. I hope hearing some of the ideas I suggest today will make taking your CureEx easier.
Go to Barriers2

### If M=LOW and C=HIGH

So you're pretty confident that you can take CureEx as prescribed, but you're not that motivated to do so.
If adherence “half or less”,
It's likely that the reason you've been taking so little of your CureEx has something to do with your motivation.
If adherence “none”,
It's likely that the reason you've not been taking your CureEx has something to do with your motivation.
Everyone,
Are there reasons that your motivation is not higher? Can you talk to your doctor about them? Perhaps with time, as the benefits of CureEx really take effect your motivation will go up. Or perhaps hearing more about some issues that lower a person's motivation to take a medicine will help.
Go to Barriers 1

### If M=LOW and C=LOW

From your answers it seems that yo're not very motivated or confident about taking CureEx as prescribed. Often these two feelings go together, but usually if you can feel more motivated your confidence will go up also. You might remind yourself about the benefits of CureEx that you have already experienced or have heard about.
If adherence “half or less”,
It's likely that the reason you've been taking so little of your CureEx has something to do with your motivation and confidence.
If adherence “none”,
It's likely that the reason you've not been taking your CureEx has something to do with your motivation and confidence.
Everyone,
Are there reasons that your motivation and confidence are not higher? Can you talk to your doctor about them? Perhaps with time, as the benefits of CureEx really take effect your motivation will go up. Or perhaps hearing more about issues that are known to lower a person's motivation to take a medicine will help.
Go to Barriers1

### Barriers1

While we are all individuals, there are a few common issues or situations that get in the way of feeling motivated about taking a medicine. Perhaps you remember a couple of calls ago I asked you about four of these issues or situations. Last time you chose <first barrier1 choice>*.
Barrier Labels for above:
   1) Concern about side effects
   2) Communication with your doctor
   3) Being reminded about your health worries
   4) Not believing in the benefits of CureEx
   5) Not to hear about any of these issues.
      If previously they chose not to hear an option,
      We encourage you to pick one of the following options this time.
      All others,
      Let me list the options, and you can pick a different one, or if you wish, you can pick the same option as you did last time and hear those suggestions again.
1. The first is being concerned about side effects from CureEx. (Side Effects)
2. Another situation is when someone feels that their doctor has not fully discussed the reasons for prescribing CureEx, how to take it, or what to expect. (MD Communication)
3. A third is that for some, taking CureEx is a reminder about their <condition> and this makes them anxious or uncomfortable. (Denial I)
4. And the last situation is when someone doesn't believe that CureEx will really benefit them or that they really need to take this medication (Denial II)
   Now let me know which of these you would most like to hear some ideas about.
   For ideas about ‘being concerned about the side effects’, Press 1 now
   For ideas about ‘feeling that your doctor has not really explained enough’ about CureEx, Press 2 now
   For ‘being reminded about your <condition> when taking CureEx’, Press 3 now
   For ‘feeling that CureEx won't really help you that much’, Press 4 now
   To not hear any of these, Press 5 now.
   To hear the options again, press 6.

### If Side Effects,

Most medications have at least some side effects and risks associated with them, but they are recommended because, for most people, the health benefits of the medication out weigh the side effects or risks of taking the medication. CureEx has been studied extensively and proven safe by the FDA, but all medicines have side effects. Read the CureEx medicine guide included in your kit as a guide. Of course for some people the side effects are more than average and outweigh the benefits. If you think this might be your situation you should talk to your doctor so you can make this decision together. Let your doctor know what you are experiencing so you can find out if this is more than what is expected, or if these side effects will lessen with time.
Go to Closing
   If Communication with Doc,
It is important that you feel that you and your doctor are communicating well. Let me make a couple suggestions that might help this situation. First, the more you know about CureEx and how it might help with <Condition> the more you will be able to ask specific questions and understand what you doctor is explaining. It's also good to write down specific questions you have for your doctor. Doctors usually like to see that their patients have taken the time to do this. And lastly, although your doctor is probably busy, don't hesitate to ask for a few extra minutes to get your questions answered.
Go to Closing

### If Reminded of Health Condition,

No one likes to be worried about their health or to be reminded of these worries. And often trying N OT to worry just makes it worse. I think the best way is to try to focus on the positive actions you are taking to protect your health and manage your <condition>. Remind yourself that your doctor is prescribing CureEx because it will help protect your health and that by taking it you're doing your part in this effort. Give yourself credit for doing this. People who take control of their condition feel better about their condition and themselves. With each dose you are doing your best to take care of your <condition>. Focus on all the possible benefits of taking CureEx. This will give you more energy to take the best possible care of yourself.
Go to Closing

### If Low Benefits,

{{Some of the feedback below will have to change depending on the specific med/condition. For example, what I have written would be more appropriate to a condition like hypertension that AIDS))
   So for yourself, you don't think CureEx will help that much. Perhaps you don't feel your <condition> is serious enough to bother taking CureEx, or perhaps you have trouble believing that a medication like CureEx will help someone like you. In both cases it would be good to discuss these thoughts with your doctor. Perhaps your doctor can point out how serious your <condition> is and what the long term risks are. Or perhaps your doctor can work with you to measure the benefit you do get from CureEx and then, as a team, you and your doctor can decide whether this benefit is important enough to continue taking CureEx. {Solite specific info like: ‘Remember with hypertension it is not what you feel now that is the problem, but that high blood pressure puts you at risk of heart attacks, stroke, and kidney failure, just to mention of few’}
Go to Closing

### If None,

OK, let's move on.
Go to Closing

### Barriers2

While we are all individuals, there are a few common issues or situations that can get in the way of taking medicine. Perhaps you remember last time I asked you about four of these and you chose <first barrier2 choice>*.
Barrier Labels for above:
   1) Ways to help remember to take your CureEx
   2) Ways to refill prescriptions on time
   3) Dealing with multiple medications
   4) Ideas about the cost of your medications
   5) Not to hear about any of these issues.
      If previously they chose not to hear an option,
      We encourage you to pick one of the following options this time.
      All others,
      Let me list the options, and you can pick a different one, or if you wish, you can pick the same option as you did last time and hear those suggestions again.
1. One difficulty that many people have is just remembering to take their medications. They have the medication, and mean to take it, but forget some of the time. (Trouble Remembering)
2. For others it's difficult to refill their medications on time. Perhaps it is hard to find the time in a busy schedule to get to the pharmacy, or to find transportation, or just to remember to do it. (Difficulty Refilling)
3. Another thing that can make taking medications more difficult is having lots of different medications to take on different schedules. (Complicated Regimen)
4. For others the cost of medications can really add up and they then decide to stretch their prescriptions out by taking less than prescribed or delaying refilling their prescriptions. (Cost)
   Now tell me which one of these you'd most like to hear about today.
   If it's difficulty remembering to take your CureEx, Press 1 now
   If it's difficulty getting your prescription refilled on time, Press 2 now
   If it's having many different medications to take, Press 3 now
   If it's the cost of your medications, Press 4 now
   To not hear any of these, Press 5 now.
   To hear the options again, press 6.

### If Remembering,

Remembering to take your medication as prescribed can be difficult for lots of different reasons, but here's a couple small bits of advice.
First if you can link taking your medication with a habit you already have, that often does the trick. For instance if you take it the same time of day as you brush your teeth, you could put the pill bottle next to your toothpaste or toothbrush and take your CureEx either before or after you brush your teeth every day. If you have to take your medication in the middle of the day and you're at home, you could put it somewhere you can see it, perhaps in the kitchen. Just make sure that young children can't get to any of your medications.
Some people have problems remembering on certain days, such as weekends when one's schedule is not regular. Remember if you link taking your CureEx to a habit that you do every day of the week, this will not be a problem.
Also, many people find a watch alarm very helpful when they need to take medicines away from home. Why not give this a try . . . it helps at home as well?
Lastly, always use some kind of pill box. It's surprising how many people have problems remembering if they took the medicine that day. If you're not sure, just check the pill box and if the compartment is empty you know you took the dose.
I hope these ideas will help.
Go to Closing

### If Refilling,

Yes, remembering to refill a prescription can be difficult. Usually you know the number of pills is getting low, but it is easy to put off getting to the pharmacy until you've gone a few days without any CureEx. It's a pity when this causes a break in the benefits of CureEx.
One simple suggestion that has helped many is to mark your calendar when you should call to get a refill. If you get in the habit of doing this every time you get a prescription filled, you will always have a reminder to get the next one filled. Just remember to mark the calendar a few days before you'll run out of your supply of CureEx.
Many people take advantage of calling their pharmacy to order a refill of CureEx. Then they just go in to pick it up.
Also, check to see about ordering your prescription through mail order. There are a number of advantages to this. First you can get 3 months supply, the co-pay is less, and it comes to your door. Some mail order systems will even call you when it's time to refill. It's worth checking into this.
I hope these ideas will help.
Go to Closing

### If Complicated Regimens,

Yes, if you are on a number of medications it can be difficult to know and remember what to take and when to take it. The first step is to make sure you know how you are supposed to take each medication. Ask your doctor or pharmacist if you are not totally clear on this. You might make a chart of what medication you are supposed to take each day and what time of day you are supposed to take them.
Another solution is using a pill box. These come in two types. One has one compartment for each day of the week, and the other has 3 compartments for each day, one for the morning, daytime, and evening. Using one of these can really help. It means taking time once a week to fill up the box with the correct pills, and then all you have to do is take the pills in the correct compartment. You can ask your pharmacist for advice about what the best pill box might be for you. And remember pill boxes are not child proof so make sure you put it in a safe place where no young children can have access.
I hope these ideas will help.
Go to Closing

### If Cost,

Yes the cost of medication can add up. Let me ask you a quick question. Do you have insurance coverage for your prescriptions? Press 1 for Yes, and 2 for No.
If Yes,
   So I imagine it is the cost of co-pays for this medication and others that add up. Talk to your doctor about this for some ideas that might help. Most doctors are used to working with their patients on this issue.
   One way to cut cost is by mail ordering your medications. For most medications this means your co-pays are substantially lower, and also means you don't have to go to the pharmacy to pick up you medications.
If No,
   Talk to your doctor about this for some ideas that might help. Most doctors are used to working with their patients on this issue.
   Also, I would see if you can get some relief from this cost through a program run by the maker of CureEx to reduce prescription costs. The name and number of this program is: <name of drug program> at <toll free number> and this information is in the material you received as part of this program. Again the information is: <name of drug program> at <toll free number>.
And finally, although I do know medications can cost a substantial amount of money, remember how important preserving your health is and how much that can save in the long run.

### Go to Closing

### If None,

OK, let's move on.
   Go to Closing

What is claimed is:

1. A computer implemented method for improving a patient's adherence to a medication regimen, said method utilizing medication specific adherence information obtained from at least one of a pharmaceutical company, a pharmacist, and a medical provider, said method comprising:
providing patient and medication specific content during a plurality of medication adherence interactions with a patient;
analyzing the medication specific adherence information to determine a medication specific drop-off point;
adjusting the timing and frequency of medication adherence interactions with the patient based on the drop-off point.

2. The method of claim 1, further comprising: adjusting the content of further medication adherence interactions with the patient based on a patient's responses in one or more previous medication adherence interactions with the patient.

3. The method of claim 2, further comprising:
deriving a patient barrier using a patient's responses to a plurality of questions from one or more medication adherence interactions;
and categorizing a patient with respect to the three segmentation factors of confidence, motivation, and previous adherence;
adjusting the content of one or more further medication adherence interactions in response to the identified barrier.

4. The method of claim 2, further comprising:
segmenting patients into high, medium, and low categories for each of the three segmentation factors of confidence, motivation, and previous adherence;
adjusting the content of one or more further medication adherence interactions to provide more content related to those segmentation factors where the patient is categorized in a low category.

5. The method of claim 3, further comprising:
reducing content related to a derived barrier when the patient indicates that the derived barrier has been overcome.

6. The method of claim 2, wherein the content is adjusted by generating a custom pathway from predetermined content.

7. The method of claim 1, further comprising:
monitoring the adherence of the patient to the medication regimen;
adjusting the frequency and content of the interaction with the patient based on the monitored adherence.

8. The method of claim 1, further comprising:
automatically providing a summarized report of a patient medication adherence interaction to the patient's medical provider.

9. The method of claim 1, wherein the patient medication adherence interaction is through at least one of a web based application and an interactive voice response system; and
wherein for each interaction, the patient can select their preferred interaction method to continue the plurality of medication adherence interactions.

10. The method of claim 1, further comprising:
providing feedback to the patient corresponding to their responses during a medication adherence interaction.

11. The method of claim 1, further comprising:
maximizing the frequency of medication adherence interactions right before and after the determined drop-off point.

12. The method of claim 1, wherein the determined drop-off point is based on the brand, type, and class of medication in the patient's medication regimen.

13. The method of claim 1, further comprising:
providing aggregated information about medication adherence interactions for multiple patients to at least one of a pharmaceutical manufacturer and a pharmacist.

14. A system for improving a patient's adherence to a medication regimen, said system comprising:
data acquisition module for receiving medication specific adherence information obtained from at least one of a pharmaceutical company, a pharmacist, and a medical provider,
display for providing patient and medication specific content during a plurality of medication adherence interactions with a patient;
processor for analyzing the medication specific adherence information to determine a medication specific drop-off point and for adjusting the timing and frequency of medication adherence interactions with the patient that are provided to said display based on the drop-off point.

15. The system of claim 14 wherein said processor adjusts the content of medication adherence interactions with the patient based on a patient's responses in one or more previous medication adherence interactions with the patient.

16. The system of claim 15 wherein said processor:
derives a patient barrier using a patient's responses to a plurality of questions from one or more medication adherence interactions;
categorizes a patient with respect to the three segmentation factors of confidence, motivation, and previous adherence;
adjusts the content of one or more further medication adherence interactions that are provided to said display in response to the identified barrier.

17. The system of claim 16 wherein said processor:
segments patients into high, medium, and low categories for each of the three segmentation factors of confidence, motivation, and previous adherence; and
adjusts the content of one or more further medication adherence interactions that are provided to said display to provide more content related to those segmentation factors where the patient is categorized in a low category.

18. The system of claim 16 wherein said processor:
reduces content related to a derived barrier provided to said display when the patient indicates that the derived barrier has been overcome.

19. The system of claim 16 wherein said processor:
monitors the adherence of the patient to the medication regimen;
adjusts the frequency and content of the interaction with the patient based on the monitored adherence.

20. The system of claim 16 wherein said processor maximizes the frequency of medication adherence interactions right before and after the determined drop-off point.
